(19) United States
(12) Patent Application Publication
(10) Pub. No.: US 2020/0240280 A1
(43) Pub. Date: Jul. 30, 2020

(54) LIGHT WEIGHT LOW BLOCKAGE SLIDER SEAL

(71) Applicant: United Technologies Corporation, Farmington, CT (US)

(72) Inventors: Curtis C. Cowan, East Hampton, CT (US); Paul W. Duesler, Manchester, CT (US); Michael R. Thomas, Bloomfield, CT (US); Michael Joseph Murphy, Windsor, CT (US)

(73) Assignee: United Technologies Corporation, Farmington, CT (US)

(21) Appl. No.: 16/260,650

(22) Filed: Jan. 29, 2019

(51) Int. Cl. F01D 11/00; F02C 7/28

(52) U.S. Cl. CPC F01D 11/005; F05D 2240/55; F02C 7/28

(57) ABSTRACT

A slider seal assembly for a gas turbine engine, comprising a housing comprising an outer surface and an inner surface, and a recessed opening between the inner surface and the outer surface, wherein the inner surface of the housing includes a flat portion configured to match a receiver on an inner wall of a casing of the gas turbine engine; a seal plate received within the recessed opening and moveable relative to the housing; and a retaining ring configured to retain the seal plate adjacent the housing, the retaining ring includes a plurality of tabs configured to retain the seal plate adjacent the housing.

### U.S. GOVERNMENT RIGHTS

This invention was made with Government support awarded by the United States. The Government has certain rights in the invention.

### BACKGROUND

This disclosure generally relates to a gas turbine engine, and more particularly to a slider seal assembly for a gas turbine engine.

In an aircraft gas turbine engine, such as a turbofan engine, air is pressurized in a compressor and mixed with fuel in a combustor for generating hot combustion gases. The hot combustion gases flow downstream through turbine stages which extract energy from the gases. In a two spool gas turbine engine, a high pressure turbine powers a high pressure compressor, while a low pressure turbine powers a fan section disposed upstream of the compressor and a low pressure compressor.

Combustion gases are discharged from the turbofan engine through a core exhaust nozzle and fan air is discharged through an annular fan exhaust nozzle defined at least partially by a nacelle surrounding the core engine. A majority of propulsion thrust is provided by the pressurized fan air which is discharged through the fan exhaust nozzle, while the remaining thrust is provided from the combustion gases discharged through the core exhaust nozzle.

The core engine components, including the compressor, the combustor and the turbine, are surrounded by a cylindrical outer casing. A multitude of interface parts, such as borescope plugs, are received within openings of the outer casing and provide access points for inspecting the internal components of the core engine. The interface parts are removable to access the interior of the core engine. For example, fiber optics equipment may be inserted into an opening of the outer casing upon removal of a borescope plug to detect debris, cracking or other damage to the interior components of the gas turbine engine.

Additionally, gas turbines engines may include numerous other interface parts, such as fuel fittings, customer bleed ports and the like. Seal assemblies are required to seal the interface between the interface parts and the openings of the outer casing. That is, the seal assemblies reduce airflow leakage between the interface parts and the outer casing as airflow is communicated within the core engine during engine operation.

The seal assemblies typically include a housing and a metallic seal plate, such as a titanium seal plate. The housing is mounted to the outer casing, the seal plate is affixed adjacent to the housing, and the interface part extends through openings of the seal plate and the housing to provide a seal therebetween. The opening of the seal plate must be machined or drilled at an angle to compensate for the curvature of the outer casing.

Disadvantageously, interface parts may experience heavy wear near the contact area between the interface part and the seal plate due to the metallic nature of the seal plate and the angle at which the interface parts extend through the seal plate. The heavy wear at this contact area may result in airflow leakage between the core airflow passage and the fan bypass airflow passage of the gas turbine engine. Increased wear at the interface between the seal assemblies and the interface parts may be furthered by thermal growth mismatch. This is caused by the severe temperature differences the engine experiences between the core airflow passage and the fan bypass airflow passage, which may cause displacement of the interface parts relative to the seal plates.

Accordingly, it is desirable to provide an effective slider seal assembly that reduces wear and reduces flow resistance and airflow leakage between the core airflow passage and the fan bypass airflow passage of a gas turbine engine.

### SUMMARY

In accordance with the present disclosure, there is provided a slider seal assembly for a gas turbine engine, comprising a housing comprising an outer surface and an inner surface, and a recessed opening between the inner surface and the outer surface, wherein the inner surface of the housing includes a flat portion configured to match a receiver on an inner wall of a casing of the gas turbine engine; a seal plate received within the recessed opening and moveable relative to the housing; and a retaining ring configured to retain the seal plate adjacent the housing, the retaining ring includes a plurality of tabs configured to retain the seal plate adjacent the housing.

In another and alternative embodiment, the receiver comprises a plate or disc attached to the inner wall of the casing of the gas turbine engine.

In another and alternative embodiment, the receiver is configured to adapt a curved surface of the inner wall of the casing into a planar surface.

In another and alternative embodiment, the receiver comprises a machined feature formed into the inner wall of the casing of the gas turbine engine.

In another and alternative embodiment, the slider seal assembly further comprises a wear strip received within the recessed opening between the seal plate and the receiver.

In another and alternative embodiment, the wear strip is configured to reduce mechanical abrasion between the seal plate and the receiver.

In another and alternative embodiment, the retaining ring is received within a slot of the recessed opening and configured to retain the seal plate within the recessed opening.

In accordance with the present disclosure, there is provided a slider seal assembly for a gas turbine engine comprising a housing comprising an outer surface and an inner surface, and a recessed opening between the inner surface and the outer surface, the housing forming a first opening, wherein the inner surface of the housing includes a flat portion configured to match a receiver formed on an inner wall of a casing of the gas turbine engine; a seal plate received within the recessed opening, the seal plate comprising a second opening extending through the seal plate, the seal plate being moveable relative to the housing; a retaining ring configured to retain the seal plate adjacent the housing, the retaining ring includes a plurality of tabs configured to retain the seal plate adjacent the housing; and an interface part extending through the first opening of the housing and the second opening of the seal plate.

In another and alternative embodiment, the interface part includes at least one of a borescope plug, a fuel fitting and a customer bleed port.

In another and alternative embodiment, the first opening includes a first diameter and the second opening includes a second diameter, wherein the first diameter is greater than the second diameter.

In another and alternative embodiment, the receiver is configured to adapt a curved surface of the inner wall of the casing into a planar surface.

In another and alternative embodiment, the slider seal assembly further comprises a wear strip received within the recessed opening between the seal plate and the receiver, the wear strip comprising a third opening configured to receive the interface part.

In another and alternative embodiment, the interface part further comprises a tube fitting coupled to the interface part, the tube fitting configured to provide an interface between the interface part and the seal plate.

In accordance with the present disclosure, there is provided a gas turbine engine system comprising an engine casing; a compressor, a combustor and a turbine housed within the engine casing; at least one slider seal assembly mounted to a receiver formed on an inner wall of the engine casing; the at least one slider seal assembly comprising a housing comprising an outer surface and an inner surface, and a recessed opening between the inner surface and the outer surface, the housing forming a first opening, wherein the inner surface of the housing includes a flat portion configured to match the receiver; a seal plate received within the recessed opening, the seal plate comprising a second opening extending through the seal plate, the seal plate being moveable relative to the housing; a retaining ring configured to retain the seal plate adjacent the housing, the retaining ring includes a plurality of tabs configured to retain the seal plate adjacent the housing.

In another and alternative embodiment, the gas turbine engine system further comprises a plurality of interface parts extending through an opening in each of the at least one slider seal assembly and the engine casing.

In another and alternative embodiment, one of the plurality of interface parts extends through one of the at least one slider seal assembly.

In another and alternative embodiment, the plurality of the at least one slider seal assembly are mounted along a plurality of locations on the engine casing.

In another and alternative embodiment, the at least one slider seal assembly is mounted on a high pressure side of the engine casing.

In another and alternative embodiment, the at least one slider seal assembly comprises a low aerodynamic profile within the engine casing.

Other details of the slider seal assembly are set forth in the following detailed description and the accompanying drawings wherein like reference numerals depict like elements.

### BRIEF DESCRIPTION OF THE DRAWINGS

FIG. 1 illustrates a general perspective view of a gas turbine engine.

FIG. 2 illustrates a general perspective view of an exemplary slider seal assembly.

FIG. 3 is another view of the exemplary slider seal assembly.

FIG. 4 illustrates a cross-sectional view of the exemplary slider seal assembly illustrated in FIG. 2.

FIG. 5 is a perspective view of the slider seal assembly.

FIG. 6 illustrates a cross-sectional view of the slider seal assembly having an interface part extending therethrough.

FIG. 7 illustrates a gas turbine engine including multiple slider seal assemblies mounted to an outer engine casing of the gas turbine engine.

FIG. 8 illustrates a cross-sectional view of a gas turbine engine including an example mounting location for a slider seal assembly.

### DETAILED DESCRIPTION

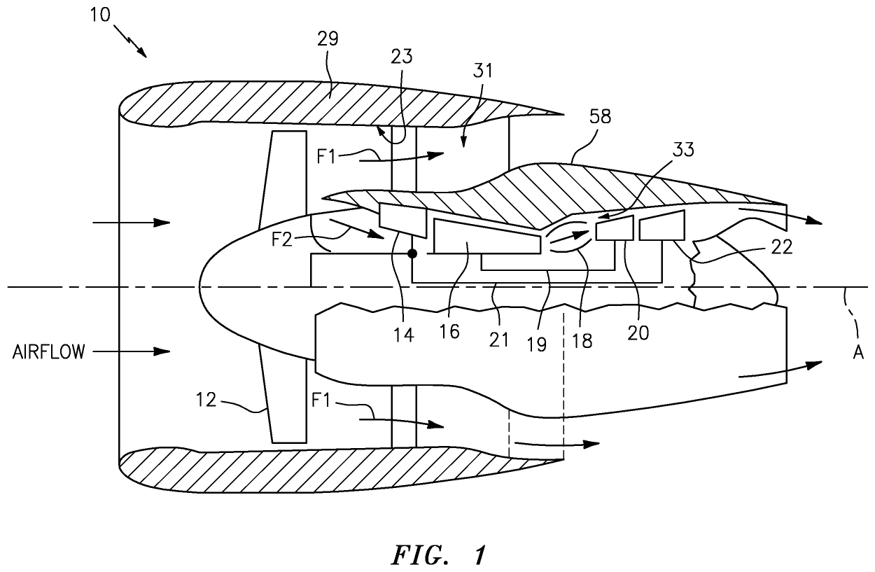

FIG. 1 illustrates a gas turbine engine 10 which includes (in serial flow communication) a fan section 12, a low pressure compressor 14, a high pressure compressor 16, a combustor 18, a high pressure turbine 20, and a low pressure turbine 22. During operation, air is pulled into the gas turbine engine 10 by the fan section 12, pressurized in the compressors 14, 16, and is mixed with fuel and burned in the combustor 18. Hot combustion gases generated within the combustor 18 flow through the high and low pressure turbines 20, 22, which extract energy from the hot combustion gases. In a two spool design, the high pressure turbine 20 powers the high pressure compressor 16 through a high speed shaft 19 and the low pressure turbine 22 powers the fan section 12 and a low pressure compressor 14 through a low speed shaft 21. However, the invention is not limited to the two spool gas turbine architecture described and may be used with other architectures such as a single spool axial design, a three spool axial design and other architectures. That is, the present invention is applicable to any gas turbine engine.

A nacelle 29 is disposed circumferentially about an engine centerline axis A and surrounds the numerous components of the gas turbine engine 10. A fan bypass passage 31 extends between an inner surface 23 of the nacelle 29 and an outer engine casing 58, which houses the compressor sections 14, 16, the combustor 18 and the turbine sections 20, 22. A portion F2 of incoming airflow enters the gas turbine engine 10 and is communicated through a core airflow passage 33, while the remaining portion F1 of incoming airflow is communicated through the fan bypass passage 31 to provide additional thrust for powering the aircraft.

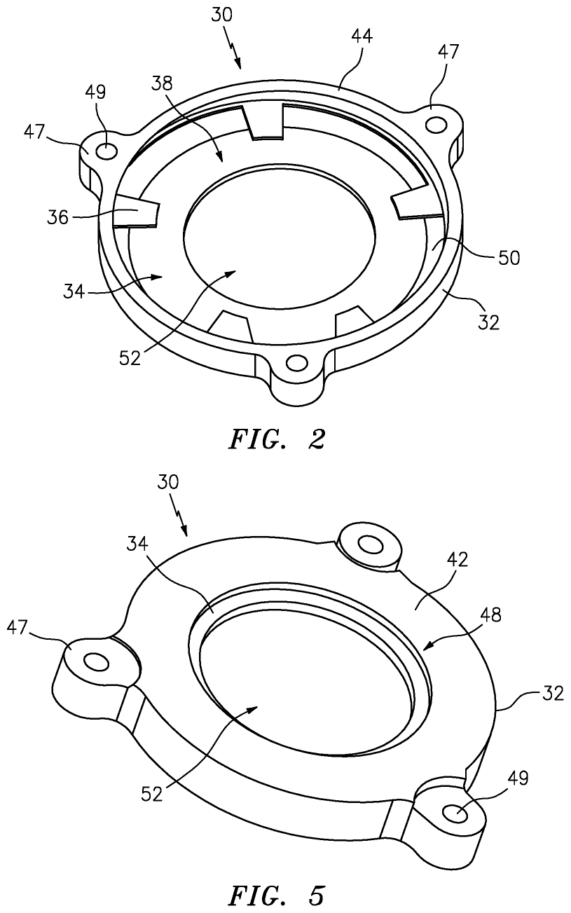

FIGS. 2-5 illustrate an exemplary slider seal assembly 30. The slider seal assembly 30 includes a housing 32, a seal plate 34, and a retaining ring 36. The housing 32 includes a recessed opening 38 for receiving the seal plate 34. The retaining ring 36 is received within a slot 40 (See FIG. 4) of the recessed opening 38 to retain the seal plate 34 within the recessed opening 38.

The housing 32 includes an outer surface 42 and an inner surface 44. The recessed opening 38 extends circumferentially from the inner surface 44 in an outward direction towards the outer surface 42. A body portion 46 of the housing 32 generally surrounds the recessed opening 38 and at least partially houses the seal plate 34 within the recessed opening 38. An opening 48 having a diameter D1 extends through the housing 32 and receives an interface part 56, as is further discussed below with respect to FIG. 6. The opening 48 opens into the recessed opening 38. The recessed opening 38 includes a diameter which is larger than the diameter D1.

The inner surface 44 of the housing 32 includes a flat portion 45. The flat portion 45 is configured to match a receiver 51 formed on an inner wall 53 of the casing 58. The receiver 51 can include a flat pad, plate, disc and the like, that is added to the inner diameter of the casing 58. In another exemplary embodiment, the receiver 51 can be machined into inner portion of the duct of the casing 58. It should be understood that the actual dimensions of the flat portion 45 will vary depending upon design specific parameters including, but not limited to, the size of the receiver 51 at the inner wall 53 of the outer engine casing 58.

The housing 32 also includes flanges 47 disposed radially outwardly from the body portion 46. The flanges 47 are disposed near opposite ends of the housing 32 and each include an opening 49 for receiving a fastener to attach the slider seal assemblies 30 to the inner wall of the engine casing 58 of the gas turbine engine 10. Each flange 47 is generally illustrated as triangular is shape, although other shapes are contemplated as would be recognized by a person of ordinary skill in the art having the benefit of this disclosure to attach the slider seal assemblies 30 to the inner wall 53 of the engine casing 58.

The seal plate 34 is received against an inner wall 50 of the recessed opening 38. The inner wall 50 is the inner surface of the outer surface 42 of the housing 32. The seal plate 34 also includes an opening 52. The opening 52 is positioned adjacent the opening 48 of the housing 32 when received within the recessed opening 38, and includes a diameter D2. The diameter D2 of the opening 52 is generally smaller than the diameter D2 of the opening 48. The seal plate 34 slides relative to the housing 32 to compensate for movement of the interface part 56. In an exemplary embodiment a wear strip 55 can be included between the seal plate 34 and the engine casing 58 (See FIG. 6). The wear strip 55 can mitigate wear of the seal plate 34 on the inner wall 53. The wear strip 55 can be fixed to the engine casing 58. In an exemplary embodiment the wear strip 55 can comprise titanium material.

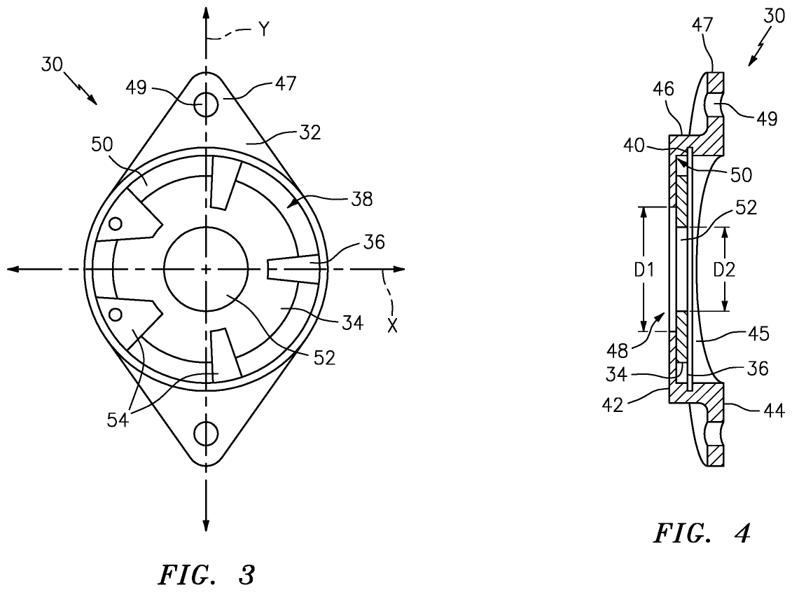

The retaining ring 36 includes a plurality of tabs 54. The tabs 54 allow movement of the seal plate 34 in axial directions X and Y relative to the housing 32 while maintaining the seal plate 34 adjacent to the inner wall 50 of the housing 32 (See FIG. 3).

Referring to FIG. 6, the interface part 56 extends from the gas turbine engine 10 through the openings 48, 52 of the housing 32 and seal plate 34 of the slider seal assembly 30. In one example, the interface part 56 is a borescope plug. In another exemplary embodiment, the interface part 56 can include an additional tube fitting 57. The fitting 57 can increase the outer diameter 59 of the interface part 56 to form an interface 60 with the seal plate 34. The gas turbine engine 10 may include multiple borescope plugs. The borescope plugs are removable for inspection of the internal components of the gas turbine engine 10, such as with fiber optics equipment.

For example, the fiber optics equipment may be used to inspect for debris, cracking or other damage to the internal components of the compressor sections 14, 16, the combustor 18, or the turbine sections 20, 22 of the gas turbine engine 10. In another example, the interface part 56 is a fuel fitting. In yet another example, the interface part 56 is a customer bleed port. It should be understood that the interface part 56 may include any part of the gas turbine engine 10 which may experience displacement as a result of thermal growth mismatch.

The slider seal assembly 30 seals the gas turbine engine 10 at the interface part 56. A seal is necessitated by providing an opening in the gas turbine engine 10 for receiving the interface part 56. During normal gas turbine engine 10 operation, there is typically a temperature difference between the airflow F2 within the core airflow passage 33 and the airflow F1 within the fan bypass passage 31 (See FIG. 8). The temperature difference may cause thermal growth mismatch between the core airflow passage 33 and the fan bypass passage 31. That is, the gas turbine engine 10 may expand and retract in both the radial and axial directions relative to the engine centerline axis A because of the extreme temperature differences. The thermal growth mismatch may result in displacement of the interface part 56. The slider seal assembly 30 is designed to compensate for the thermal growth mismatch and provide lubrication at wear surfaces W, as the interface part 56 travels during the thermal growth mismatch. The wear surfaces W represent the wear areas that result from the interface parts 56 rubbing against the seal plate 34 and the housing 32 during thermal growth mismatch.

The interface part 56 extends through the opening 48 of the housing 32 in a direction normal to the outer surface 42. Because the seal plate 34 is slideable relative to the housing 32, the interface part 56 extends in a direction normal to the outer surface 42 during engine operation, and maintains the perpendicular positioning during any thermal growth mismatch. That is, the seal plate 34 slides in the axial directions X and Y (See FIG. 3) in response to any expansion/retraction by the gas turbine engine 10. As stated above, the diameter D1 of the opening 48 of the housing 32 is larger than the diameter D2 of the opening 52 of the seal plate 34. Therefore, the interface part 56 has enough clearance space to avoid contact with the housing 32 during displacement caused by thermal growth mismatch. The slider seal assembly 30 therefore reduces rubbing at the wear surfaces W, reduces the amount of corner scraping between the seal plate 34 and the interface part 56, and improves leakage performance of the gas turbine engine 10.

The seal plate 34 can include a fiber reinforced composite. The composite material further reduces contact between the interface part 56 and the wear surfaces W of the seal plate 34 and the housing 32. In one example, the fiber reinforced composite is NR150. In another example, the composite includes PMR15. It should be understood that the seal plate 34 may be comprised of any other composite type material, including any known polyimide composite material.

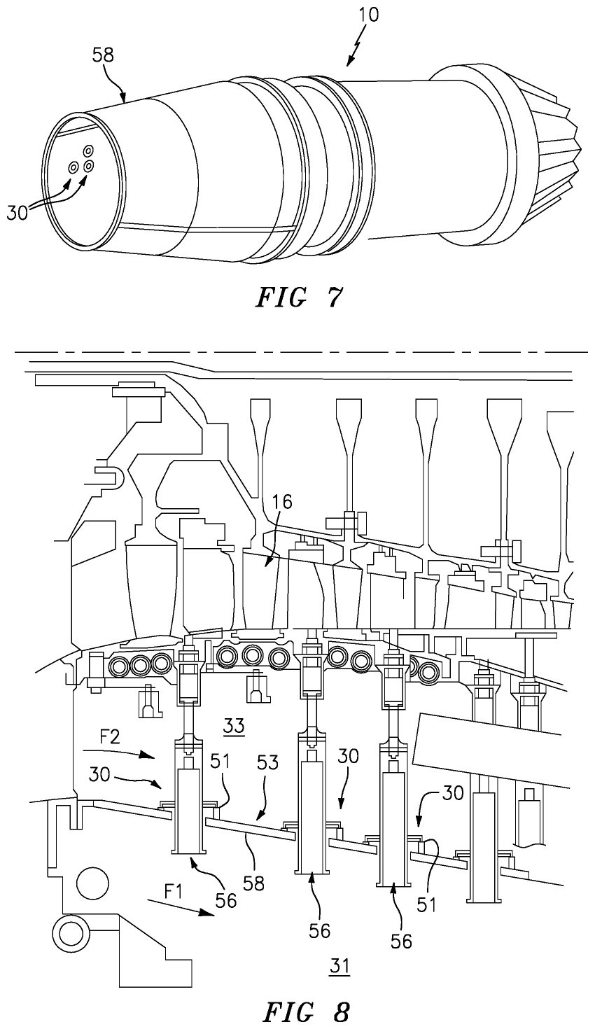

FIG. 7 illustrates an example gas turbine engine 10 including a plurality of slider seal assemblies 30. The slider seal assemblies 30 are mounted to the inner wall 53 of the engine casing 58 of the gas turbine engine 10. Multiple slider seal assemblies 30 may be mounted adjacent to the compressor sections 14, 16, the combustor 18, the turbine sections 20, 22 or any other section of the gas turbine engine 10. The flat portion 45 of the inner surface 44 of each housing 32 (See FIG. 4) is configured to match the receiver 51 of the inner wall 50 of the engine casing 58. The flat portion 45 of the inner surface 44 provides an improved interface between the slider seal assemblies 30 and the inner wall 50 of engine casing 58, thereby reducing airflow leakage.

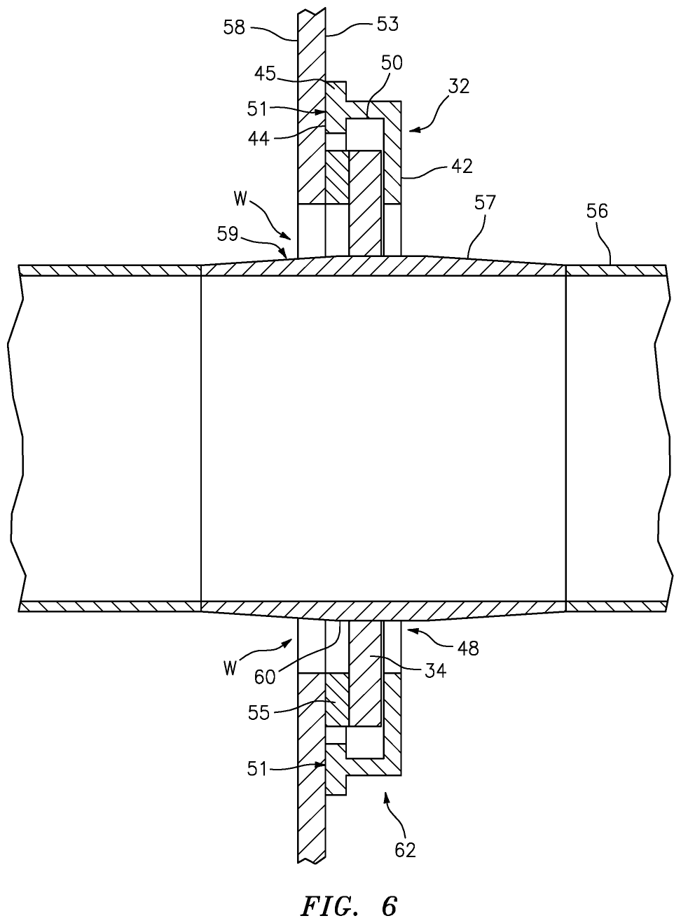

FIG. 8 illustrates an exemplary mounting location for the slider seal assemblies 30. In this example, several slider seal assemblies 30 are mounted adjacent to the high pressure compressor 16 of the gas turbine engine. Interface parts 56 extend through the outer engine casing 58, through the openings 52 of each seal plate 34, and through the openings 48 of each housing 32 of each slider seal assembly 30. The interface parts 56 extend in a direction normal to the outer surface 42 of each housing 32. Therefore, during displacement of the interface parts 56 caused by thermal growth mismatch between the core passage 33 and the fan bypass passage 31, the friction load on the interface part 56 is reduced and wear is reduced at the wear surfaces W (See FIG. 5). The slider seal assemblies 30 provide adequate sealing between the interface parts 56 and the gas turbine engine 10, which provides improved efficiency of the gas turbine engine 10.

Another technical advantage to the disclosed slider seal assembly 30 being mounted within the engine casing 58 is that the slider seal 30 comprises a low aerodynamic profile 62 within said engine casing 58. The low aerodynamic profile 62 reduces flow loss within the engine casing 58 for improved fluid flow. The low aerodynamic profile 62 creates a lower flow loss when compared to the prior seal designs as shown in FIG. 1.

The disclosed slider seal 30 also reduces the weight of the engine 10.

There has been provided a slider seal assembly. While the slider seal assembly has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A slider seal assembly for a gas turbine engine, comprising:
a housing comprising an outer surface and an inner surface, and a recessed opening between said inner surface and said outer surface, wherein said inner surface of said housing includes a flat portion configured to match a receiver on an inner wall of a casing of the gas turbine engine;
a seal plate received within said recessed opening and moveable relative to said housing; and
a retaining ring configured to retain said seal plate adjacent said housing, said retaining ring includes a plurality of tabs configured to retain said seal plate adjacent said housing.

2. The slider seal assembly according to claim 1, wherein said receiver comprises a plate or disc attached to the inner wall of the casing of the gas turbine engine.

3. The slider seal assembly according to claim 1, wherein said receiver is configured to adapt a curved surface of said inner wall of the casing into a planar surface.

4. The slider seal assembly according to claim 1, wherein said receiver comprises a machined feature formed into the inner wall of the casing of the gas turbine engine.

5. The slider seal assembly according to claim 1, further comprising:
a wear strip received within said recessed opening between said seal plate and said receiver.

6. The according to claim 5, wherein said wear strip is configured to reduce mechanical abrasion between said seal plate and said receiver.

7. The according to claim 1, wherein said retaining ring is received within a slot of the recessed opening and configured to retain said seal plate within said recessed opening.

8. A slider seal assembly for a gas turbine engine comprising:
a housing comprising an outer surface and an inner surface, and a recessed opening between said inner surface and said outer surface, said housing forming a first opening, wherein said inner surface of said housing includes a flat portion configured to match a receiver formed on an inner wall of a casing of the gas turbine engine;
a seal plate received within said recessed opening, said seal plate comprising a second opening extending through said seal plate, said seal plate being moveable relative to said housing;
a retaining ring configured to retain said seal plate adjacent said housing, said retaining ring includes a plurality of tabs configured to retain said seal plate adjacent said housing; and
an interface part extending through said first opening of said housing and said second opening of said seal plate.

9. The slider seal assembly according to claim 8, wherein said interface part includes at least one of a borescope plug, a fuel fitting and a customer bleed port.

10. The slider seal assembly according to claim 8, wherein said first opening includes a first diameter and said second opening includes a second diameter, wherein said first diameter is greater than said second diameter.

11. The slider seal assembly according to claim 8, wherein said receiver is configured to adapt a curved surface of said inner wall of the casing into a planar surface.

12. The slider seal assembly according to claim 8, further comprising:
a wear strip received within said recessed opening between said seal plate and said receiver, said wear strip comprising a third opening configured to receive said interface part.

13. The slider seal assembly according to claim 8, wherein said interface part further comprises a tube fitting coupled to said interface part, said tube fitting configured to provide an interface between said interface part and said seal plate.

14. A gas turbine engine system comprising:
an engine casing;
a compressor, a combustor and a turbine housed within said engine casing;
at least one slider seal assembly mounted to a receiver formed on an inner wall of said engine casing;
said at least one slider seal assembly comprising:
a housing comprising an outer surface and an inner surface, and a recessed opening between said inner surface and said outer surface, said housing forming a first opening, wherein said inner surface of said housing includes a flat portion configured to match said receiver; a seal plate received within said recessed opening, said seal plate comprising a second opening extending through said seal plate, said seal plate being moveable relative to said housing; a retaining ring configured to retain said seal plate adjacent said housing, said retaining ring includes a plurality of tabs configured to retain said seal plate adjacent said housing.

15. The gas turbine engine system of claim 14, further comprising:
a plurality of interface parts extending through an opening in each of said at least one slider seal assembly and said engine casing.

16. The gas turbine engine system of claim 15, wherein one of said plurality of interface parts extends through one of said at least one slider seal assembly.

17. The gas turbine engine system of claim 14, wherein a plurality of said at least one slider seal assembly are mounted along a plurality of locations on said engine casing.

18. The gas turbine engine system of claim 14, wherein said at least one slider seal assembly is mounted on a high pressure side of said engine casing.

19. The gas turbine engine system of claim 14, wherein said at least one slider seal assembly comprises a low aerodynamic profile within said engine casing.
